(19) United States
(12) Patent Application Publication
(10) Pub. No.: US 2002/0002600 A1
(43) Pub. Date: Jan. 3, 2002

(54) Information retrieval apparatus and method using regional information

(75) Inventors: Teruhiro Yamada, Osaka (JP); Mutsumi Ikeda, Saitama (JP); Atsushi Maeda, Osaka (JP); Tsugufumi Matsuoka, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,243

(22) Filed: Mar. 30, 2001

(30) Foreign Application Priority Data
Jun. 30, 2000 (JP) 2000-200348
Dec. 7, 2000 (JP) 2000-373586

(51) Int. Cl. G06F 15/16

(52) U.S. Cl. 709/219

(57) ABSTRACT

An information retrieval apparatus that enables users to search information with regionality is provided. When a user inputs search terms for searching, a place-name is extracted from the search terms. Furthermore, the apparatus extracts another place-name of a region that is judged to be within a reachable area from the region indicated by the extracted place-name. Regional information is searched using the extracted place-name and the selected place-name. The user may search life-related information with regionality at his/her residence. The user registers the items of the life-related information beforehand. When the user moves to a new address, the apparatus searches life-related information of the new address based on the registered items and presents the updated information to the user.

### BACKGROUND OF THE INVENTION

1. Field of the Invention

The present invention relates to an information retrieval technique, and it particularly relates to an information retrieval apparatus and method that receive an input of a place-name to limit a region to be searched when a user searches information. It also relates to an information retrieval technique by which life-related information with regionality is retrieved.

2. Description of the Related Art

Although WWW (World Wide Web) is one of applications in the Internet, WWW is becoming an indispensable means for providing and retrieving information in the Internet. With an explosive growth of Web sites, the amount of offered information is increasing rapidly, and it becomes an important issue in utilizing the WWW how to find really necessary information in a short time.

Recently, a mechanism using a search robot is commonly applied to portal Web sites for information retrieval. The robot visits many Web sites periodically and automatically extracts key words from Web pages in the Web sites so that users can efficiently search the Web sites or the Web pages in the future.

Generally the robot chooses the words in the Web pages as the key words to be registered. Therefore, the inventors of the present invention recognized that it has not been realized to allow ambiguity in a good sense in information retrieval, which is inevitable in searching information.

For instance, when a user searches a wine shop in Shinjuku, “Shinjuku” and “wine” may be used for search terms, and a logical multiplication of these terms, that is, an AND condition is set as a query expression. In this case, even if a wine shop exists in Shibuya, the shop is not normally found in the search. However, the user may not mind visiting the shop in Shibuya, considering a relatively short distance between Shinjuku and Shibuya. Such ambiguous information does not meet the present query expression and is neglected in the search.

As another example, when a user searches a Chinese restaurant in Yokohama, “Yokohama” and “Chinese restaurant” may be used as the search terms, and an AND condition of these terms is set as a query expression. In this case, even if a restaurant has a Web page saying, “Our restaurant is the most popular Chinese restaurant in China Town”, the restaurant is not found in the search when “Yokohama” is not included in the description. It is possible that the user means China Town rather than Yokohama. This kind of problem is not inherent in the search robot mechanism, but the same issue will possibly occur in a search engine site where an administrator of the site registers key words by hand.

Furthermore, information services such as a search engine and Yellow Pages are in wide use in the Internet and Web pages of a company, a store, or a public facility can be browsed by a personal computer at home or a mobile phone. The emphasis of WWW has been put on the aspect that worldwide information can be browsed by a personal computer, but recently information provision has been attempted from a viewpoint of regionality or locality. For instance, local supermarket can offers information about today's bargain sale to local residents via the Internet. Such a local information service may increase in the future. A mobile phone and a PDA, Personal Digital Assistant, are in common use and it can be expected that regional information such as a clinic, a school, or a post office might be stored and used electronically in such a portable terminal.

Although a user can store life-related information with regionality searched in a personal computer, a mobile phone, or a PDA, if the user moves and his/her residence changes, the stored life-related information becomes meaningless. In addition, when the user travels or goes on business, the stored local information becomes useless. It is a time-consuming job for the user to search again similar life-related information when his/her residence changes. It is also troublesome for the user to search local information fit to his/her preference or needs, when he/she travels on vacation or on business and his/her living place changes temporarily.

### SUMMARY OF THE INVENTION

The present invention has been made in view of the above-mentioned problems recognized by the inventors, and an object thereof is to provide an information retrieval technology by which ambiguity in information retrieval can be realized particularly in respect of a place-name. Another object of the present invention is to provide an information retrieval technology by which life-related information with regionality can be obtained effectively.

According to one aspect of the present invention, an information retrieval apparatus is provided. The apparatus includes an inputting unit which receives an input of a key word straightforwardly describing information to-be searched by a user, and a place-name to apply a regional restriction to searching, a selecting unit which selects a place-name of a region that is judged to be within a reachable area from a region indicated by the inputted place-name on the basis of a predefined judgment criterion, a setting unit which sets a logical multiplication or logical AND of a logical addition or logical OR of the inputted place-name and the selected place-name, and the key word, as a query expression, and a searching unit which searches the information by using the query expression. The word “region” may be replaced by “place” or “area”.

Although the place-name that is used for searching is also a key word in a broad sense, a key word in this specification refers to a straightforward expression or word describing the concept corresponding to the information to be searched and it differs from the place-name. The place-name is a search term as well as the key word.

In this configuration, when a user searches information, he/she enters a key word and a place-name via the inputting unit. Next, the selecting unit selects a place-name of a region that is judged to be within a reachable area on the basis of a predefined judgment criterion. The judgment criterion is, for instance, whether it is within 20 minutes by rail in consideration for a transfer means of the user. The transfer means may include “on foot” as well as a means of transportation.

Another example of the judgment criterion is whether it is within 10 kilometers in a straight line. In order to judge on this criterion, the apparatus may have a table which stores a place-name associated with absolute location information of a region indicated by the place-name. The selecting unit may choose from said table a place-name of a region from which the region indicated by the inputted place-name is far within a predefined distance, by using the absolute location information. The absolute location information is for example the latitude and longitude of the region indicated by the place-name. Since the region may stretch to some extent, a standard point to define the location may be used, for instance a center of the region.

According to another aspect of the present invention, an information retrieval apparatus is also provided. The apparatus includes an inputting unit which receives a search term inputted by a user for searching information, an extracting unit which extracts a place-name from the inputted search term, a selecting unit which selects a place-name of a region that is judged to be within a reachable area from a region indicated by the extracted place-name on the basis of a predefined judgment criterion, a setting unit which sets a query expression including a logical addition of the extracted place-name and the selected place-name, and a searching unit which searches the information by using the query expression.

The inputting unit may receive personal information of the user, and the selecting unit may select the place-name after defining or modifying the reachable area using the personal information. For instance, the personal information relates to a range of activities, a behavioral pattern, or an area of activities of the user. If the user is a old person or a child, the range of activities may be restricted. In this case, the reachable area may be narrowed or restricted to the area along the route of a train or a bus the user usually takes.

According to yet another aspect of the present invention, an information retrieval method is provided. The method includes obtaining information related to a location of a user, extracting an item of life-related information with regionality at the location from information retrieved by the user, obtaining information related to a destination of the user, and searching life-related information with regionality at the destination by using the extracted item.

The user location and the destination are where a user lives, stays or goes in general and includes the place of work, a new residence, and the destination in travel on business or on vacation.

According to still another aspect of the present invention, an information retrieval method is also provided. The method includes storing an item of life-related information with regionality, obtaining information related to a destination of a user, and searching life-related information with regionality at the destination by using the stored item without receiving an input of the item from the user.

According to still another aspect of the present invention, an information retrieval method is also provided. The method includes storing a personal attribute of a user, obtaining information related to a destination of the user, and searching life-related information with regionality at the destination by using the personal attribute without receiving a search item from the user. The personal attribute may be an objective attribute such as age, sex, address, profession, or may be an subjective attribute such as preference or hobbies.

According to still another aspect of the present invention, an information retrieval apparatus is provided. The apparatus includes a life-related information storing unit which stores an item of life-related information with regionality for each user, a destination obtaining unit which obtains information related to a destination of a user, a searching unit which searches life-related information with regionality at the destination by using the stored item, and a transmitting unit which transmits the searched life-related information to a terminal of the user.

According to still another aspect of the present invention, a terminal is provided. The terminal includes a search history storing unit which stores a history about information searched by a user, a location obtaining unit which obtains information related to a location of the user, an extracting unit which extracts an item of life-related information with regionality at the location based on the history, and a communication unit which transmits information related to a destination of the user and the extracted item to a server, and receives life-related information with regionality at the destination that is searched by the server.

Moreover, any arbitrary combination of the above-mentioned structural components in the present invention is still effective as an embodiment when applied as a method, a system, a server, a terminal, and a computer program, and so forth.

This summary of the invention does not necessarily describe all necessary features so that the invention may also be a sub-combination of these described features.

### BRIEF DESCRIPTION OF THE DRAWINGS

FIG. 1 is a block diagram of an information retrieval apparatus according to an embodiment.

FIG. 2 is an internal data structure of a personal information table.

FIG. 3 is one internal data structure of a place-name table.

FIG. 4 is another internal data structure of a place-name table.

FIG. 5 is yet another internal data structure of a place-name table.

FIG. 6 is a block diagram of an information retrieval system according to the second embodiment.

FIG. 7 is a block diagram of a user terminal and a searching server.

FIG. 8 shows an example of a screen of a user terminal.

FIG. 9 shows a life data file that stores items of life-related information of a user.

FIG. 10 shows a search result of life-related information at a new address.

FIG. 11 is a flow chart of an information retrieval procedure by a searching server.

FIG. 12 is a block diagram of a user terminal and a searching server according to the third embodiment.

FIG. 13 shows an example of life-related information displayed in a user terminal.

### DETAILED DESCRIPTION OF THE INVENTION

The invention will now be described on the basis of the preferred embodiments, which do not intend to limit the scope of the present invention, but exemplify the invention. All of the features and the combinations thereof described in the embodiment are not necessarily essential to the invention.

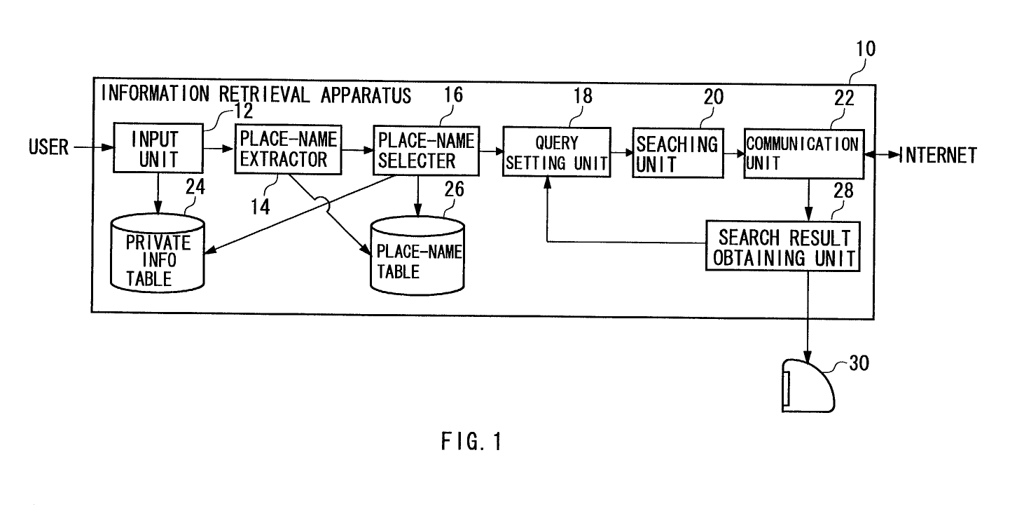

The first embodiment of the present invention is explained. FIG. 1 shows a block diagram of an information retrieval apparatus 10 according to the first embodiment of the present invention. The structure of the apparatus 10 may be implemented with a CPU, memory and a program with a regional information retrieving function loaded in the memory. In the figure, however, the blocks are not divided in terms of hardware and/or software component, but in terms of function. The skilled in the art can therefore understand that the various combinations of hardware and software components can achieve the function of these blocks. In particular, the software components in the apparatus 10 are implemented, for example, in such a manner that the regional information retrieving function that characterizes the present invention is embedded into a main function for Web browsing. Therefore, it is herein assumed that the information retrieval is performed using WWW (World Wide Web) in such a configuration.

An input unit 12 obtains data inputted by a user using a keyboard, a mouse, or other external equipments, here a search term, user's personal information, and so on. The search term is forwarded to a place-name extracting unit 14 and the personal information is stored into a personal information table 24.

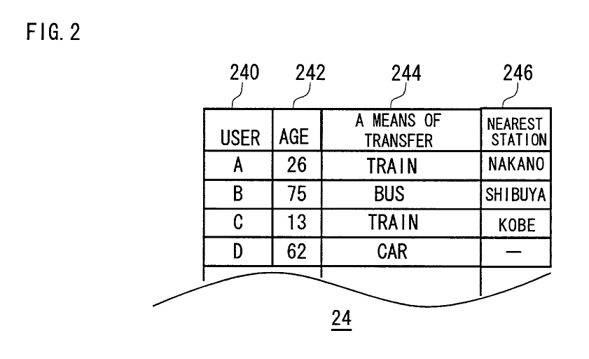

FIG. 2 shows the internal data structure of the personal information table 24. The personal information table 24 includes a user field 240, an age field 242, a means of usual transportation field 244, and a nearest station field 246. For instance, it is recognized that the user A is 26 years old and usually transfers from Nakano station by train. The user B and D are relatively old and the user D mainly transfers by car. Such personal information is utilized for defining a reachable area for each user, as described later.

Now assume that the input data is not spaced word by word but given in a statement, “I want to buy good wine at Shinjuku.” The place-name extracting unit 14 decomposes into morphemes, and extracts the nouns, “Shinjuku” and “wine” at least, and then utilizes them as the search terms. Next, the place-name extracting unit 14 extracts a place-name from the search terms. As an example of the way of extracting the place-name, the extracting unit 14 refers to a place-name table 26 that stores place-name related information, and extract a noun, here “Shinjuku” which corresponds to one of the place-names in the table. The extracted place-name “Shinjuku” is forwarded to a place-name selecting unit 16. The place-name selecting unit 16 chooses from the place-name table 26 some place-names that are within a pre-defined area around “Shinjuku”, and then forwards them to a query setting unit 18.

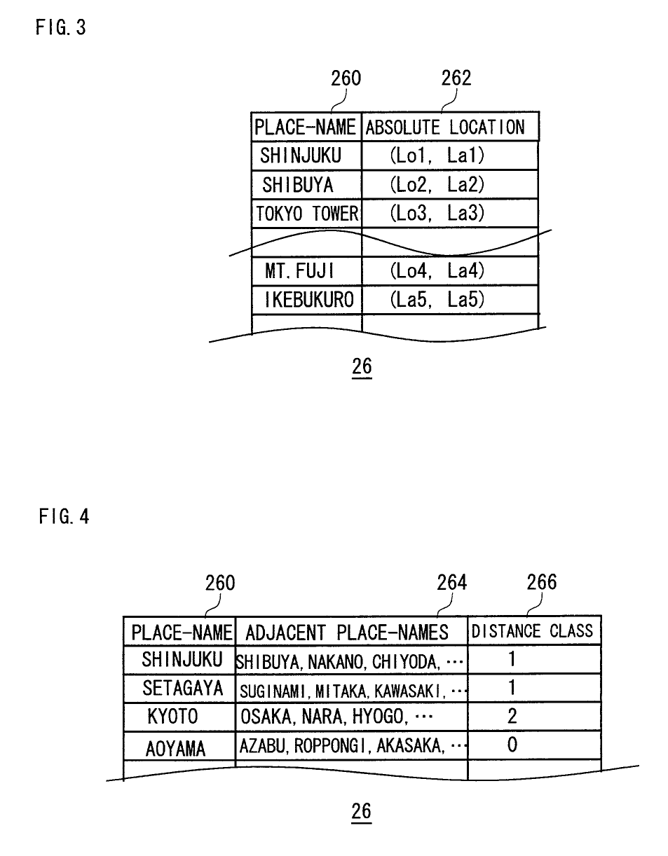

FIG. 3 shows an example of the internal data structure of the place-name table 26. A place-name field 260 and an absolute location field 262 are provided in this example, and the latter is expressed in the form (Loi, Lai) (i=1, 2, . . . ) which indicates longitude and latitude respectively. In the place-name field 260, a sightseeing spot such as “Tokyo Tower”, the name of a structure, the name of the natural place such as “Mt. Fuji” are filled as well as administrative divisions such as town, ward, city, and prefecture. In the absolute location field 262, there are the standard location of each place-name, for example, a city hall or other administrative agencies for the administrative division, and the longitude and latitude of the central point or the summit for the natural place. In any cases, a rough central point may be used. Any geometrically defined unique points may be adopted, for example the center of gravity of a rectangle circumscribing the area indicated by the place-name.

Since the absolute location of the region indicated by each of the place-name is obtained from the place-name table 26, the distance between the regions is determined. The region within 6 kilometers is determined as the reachable area for the user at an initial state. Therefore, the place-name selecting unit 16 chooses the place “Shibuya” and “Ikebukuro” within 6 kilometers from “Shinjuku”.

The query setting unit 18 deals with the original place-name “Sinjuku”, and the place name “Shibuya” and “Ikebukuro” selected by the place-name selecting unit 16 as an acceptable area for the information retrieval, while utilizing the word “wine” for searching information. Here, as an example, the query expression is set as “(Shinjuku OR Shibuya OR Ikebukuro) AND wine”, and forwarded to a searching unit 20. The searching unit 20 itself may be a search engine, or may have a control function for sending a search command to a search engine in a portal Web site. The searching unit 20 may deal with a meta-search engine that exploits multiple search engines at the same time. In this case, the system can save the user a lot of labor and avoid biased search in a single search engine. In any case, Web sites and their Web pages are searched under the above query expression via a communication unit 22, and then some matched Web pages are obtained at a search result obtaining unit 28 via the communication unit 22, and the result is displayed as a list in a display 30. If the number of the matched pages exceeds a predefined threshold at the search result obtaining unit 28, the query setting unit 18 is notified and a new search term may be added. In the above-mentioned example, the terms “store”, “sales”, or “good quality” may be added. Thus, the user can find a store that sells quality wine in Shibuya and Ikebukuro as well as Shinjuku.

As another way of the place-name selecting unit 16 utilizing the personal information table 24, the reachable area can be extended or narrowed according to the user's age. For instance, since the user B is old, it can be assumed that he/she normally does not walk a long distance for shopping. Therefore, the information may be searched under the narrowed reachable area. Furthermore, if it is taken into consideration that the user B gets on a bus from Shibuya, the place-names along the regular route of the bus may be added as OR conditions in the query expression. For this purpose, the route maps of trains and busses may be prepared and the information retrieval apparatus 10 may add the areas along the route S for users who uses a certain route S into his/her normal reachable area, or alternatively choose the place-names along the route S as the selected place-names.

Although the user D is relatively old, but he/she transfers mainly by car, the place-name may be chosen after the areas along the main road are added to his/her normal reachable area. In this case, it is preferable that the address of the user D is obtained. Even if he/she transfers by car, there may be a high possibility that he/she should be within the region around his/her house, and therefore it is reasonable that the reachable region should be defined after taking this point into consideration.

FIG. 4 shows another example of the place-name table 26. In this example, the place-name table 26 stores a proximity relation between the regions indicated by the place-names, or particularly an adjacent relation. For example, some adjacent wards such as “Shibuya, Nakano, Chiyoda” are filled in an adjacent place-name field 264 corresponding to the place-name “Shinjuku”, and other adjacent wards such as “Osaka, Nara, Hyogo” are likewise filled corresponding to “Kyoto”. The place-name table 26 further has a distance classification field 266. A value is filled in this field, and the bigger the value is, the larger the scale or unit of the regions in the adjacent relation becomes, that is, the larger the distance between the adjacent regions becomes. For instance, the distance classification is set to 0 for the adjacent towns within the same ward, 1 for the adjacent wards, and 2 for the adjacent prefectures. By using the distance classification, the place-name selecting unit 16 can select the place-name as follows.

1. Select “0” as the distance classification for users who go on foot, so that only very closely adjoining towns are set as the reachable area.

2. Select “0” or “1” as the distance classification for the aged, or may select “2” for users who can transfer by car like the user D.

3. Cancel the restriction on the distance for the areas along the train route that users usually take.

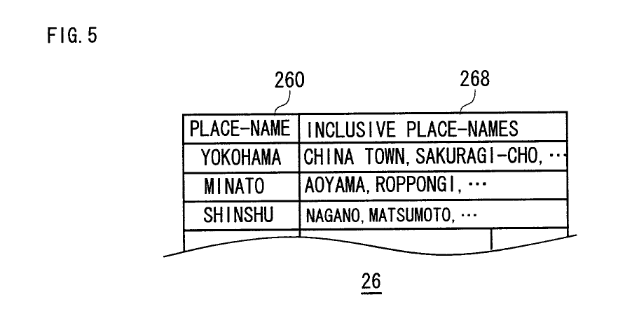

FIG. 5 shows yet another example of the place-name table 26. In this example, the place-name table 26 stores an inclusive relation between the regions indicated by the place-name. For instance, “Yokohama” in the place-name field 260 contains “China Town” and “Sakuragi Town” in an inclusive region field 268. Therefore, even if the user simply inputs “Yokohama” as the search term, it is not likely that “Yokohama”-related regional information such as “China Town” should be missed. Of course, the regional name such as “Shinshu” may be used for the place-name as well as towns and cities. A noted structure, a natural place, a noted place or other region-related things can be adopted as the name of the inclusive region.

Some alterations are now explained. Although the absolute distance between regions is considered in FIG. 3, it may be replaced with transfer time between the regions. Namely, the time duration of transferring from one region to another by rail, bus, or air may be considered as a distance between the regions, and used to define the reachable area.

Moreover, an area code or a postal code may be used for creating the place-name table 26. Since these codes are numerical data, it is convenient in respect of system implementation.

Furthermore, although a town or a ward is a searchable unit in the above embodiment, a smaller region can be searched. In the above-mentioned embodiment, Shibuya-Ku, that is, the whole ward of Shibuya may be searched under a query expression of “Shibuya” and it may causes a difficulty knowing that the searched area is within walking distance. In such a case, the names of towns or places in the neighborhood, for instance within some specified distance, may be obtained by using the latitude and longitude of a certain town in the ward of Shibuya or the Shibuya station, and these names may be used as OR conditions in the query expression so that more detailed search can be conducted. This function may be implemented in the place-name selecting unit 16, for instance.

Moreover, the search may be conducted in the order of proximity. For instance, a physical distance, such as within 100 meters, 300 meters, 500 meters, and so on, may be used and the search result may be shown in this order. Time duration such as with in 10 minutes, 20 minutes, and 30 minutes, or transfer cost such as within 200 yen and 500 yen may be also used.

After the classification using these kinds of distance metrics is executed as a front-end process, information relating to the closest region may be first searched and after that, information relating to the next to the closest region may be searched. In this configuration, all that users do is to wait until desired information is searched. Therefore, the uses can avoid a difficulty in finding which searched result is related to the closest region when the search is conducted at one time and all results are shown at once. In addition, some existing search engines cannot process an OR search with many key words. In this configuration, the users can avoid this constraint in the search engines. This function may be also implemented in the place-name selecting unit 16.

Moreover, although the information retrieval apparatus 10 is depicted as a client apparatus residing at the user side, this apparatus may be configured as a server apparatus. For instance, the apparatus can be provided in a Web server that offers a search service to many clients, such as a home server controlling electronic equipments at home, a server controlling OA or FA (Factory Automation) equipments. As such an example, if a Web server also serves as the information retrieval apparatus 10, the inputting unit 12 of FIG. 1 will receive a request sent by the user via the Internet or other networks and perform a sequence of the processes described above in the server.

As a still another configuration, the information retrieval apparatus 10 may be implemented as a client-server system. As an example, the inputting unit 12 and the place-name extracting unit 14 may be provided at the client side and the other function blocks may be provided at the server side. As a matter of course, the function blocks in the configuration of FIG. 1 may be divided differently into the client side and the server side. The functional blocks can be appropriately divided when conditions, such as user convenience at the client side, a server load, the amount of communication data, are taken into consideration.

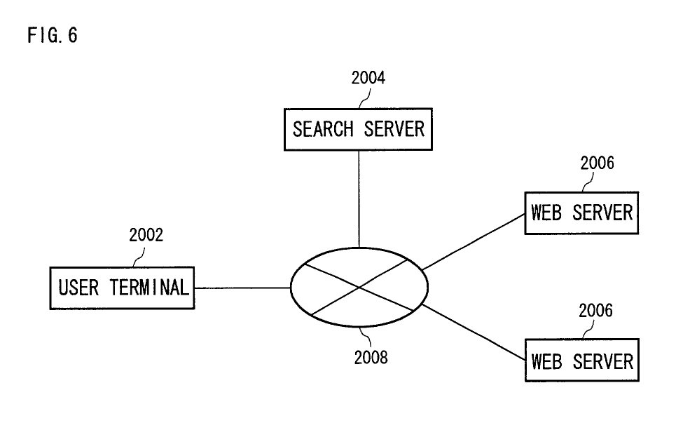

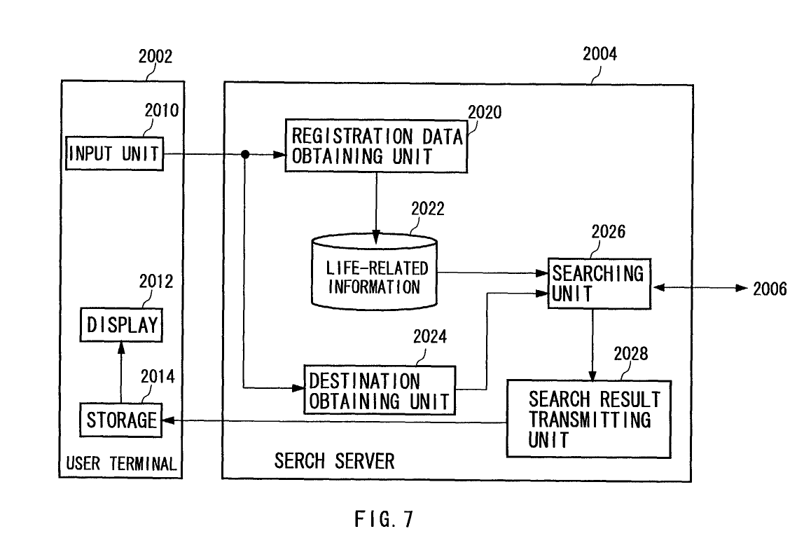

The second embodiment of the present invention is now explained. FIG. 6 shows a block diagram of the information retrieval system according to this embodiment. A user terminal 2002, a searching server 2004, and a Web server 2006 are connected via the Internet 2008. The user terminal 2002 accesses to the searching server 2004 and retrieves information offered by the Web server 2006. FIG. 7 is a block diagram of the user terminal 2002 and the searching server 2004. The user terminal 2002 may be a personal computer, a portable terminal such as a personal data assistant, or a mobile phone. The searching server 2004 is preferably implemented using a normal computer and has a registration data obtaining unit 2020, a life-related information storing unit 2022, a destination obtaining unit 2024, a searching unit 2026, and a searching result transmitting unit 2028, as its function blocks.

An inputting unit 2010 of the user terminal 2002 receives the items of life-related information and information related to a destination inputted by a user. The registration data obtaining unit 2020 of the searching server 2004 registers the inputted items of the life-related information to the life-related information storing unit 2022. The items of the life-related information have regionality at the location of the user. For instance, the item may be a generic name of a public facility such as a hospital, a school or a post office, or may be a specific name of a frequented store or a favorite restaurant. The destination obtaining unit 2024 receives information related to the destination inputted by the user and provides the information to the searching unit 2026. The information related to the destination is, for instance, an address, a postal code, or an area code of a telephone number. The searching unit 2026 searches life-related information with regionality at the destination by using the items of the life-related information stored in the life-related information storing unit 2022. For example, the searching unit 2026 searches information related to a store at the destination that is the same as the frequented one at the present location. The searching unit 2026 may also search information related to a school or a hospital that is located near the destination. The search result transmitting unit 2028 transmits the searched life-related information to the user terminal 2002. The user terminal 2002 stores the received life-related information to a storage unit 1014 and displays the information in a display unit 1012.

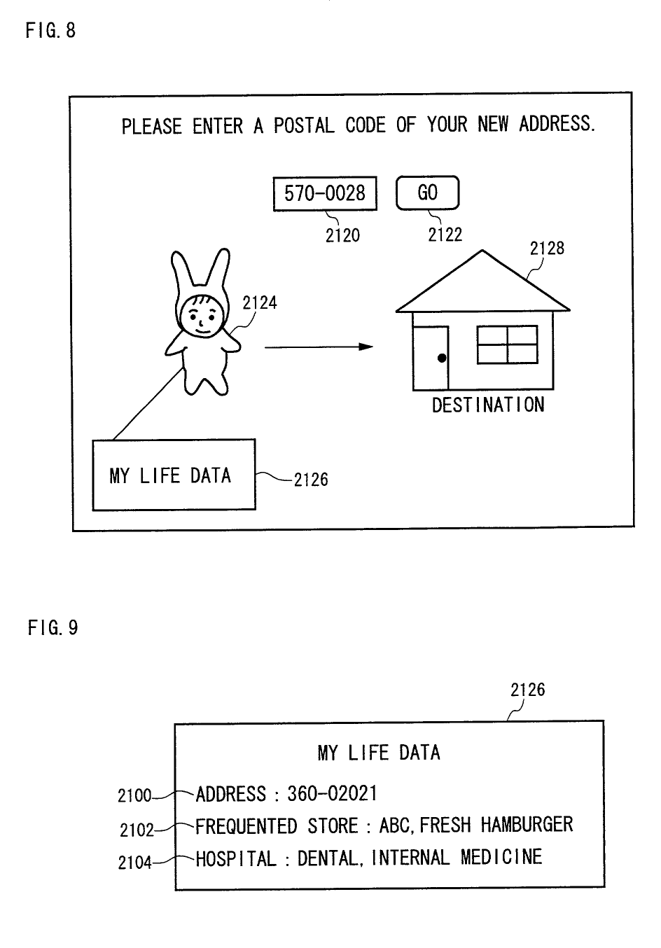

FIG. 8 explains a screen of the user terminal 2002. A character 2124 has an internal life data file 2126 storing the items of the life-related information of the user. The life data file 2126 is stored beforehand in the life-related information storing unit 2022 of the searching server 2004. The life data file 2126 has, for instance, an address field 2100, a frequented store field 2102, and a hospital filed 2104 as shown in FIG. 9. A postal code is stored in the address field 2100. Some specific names of stores visited frequently by the user are stored as the items in the frequented store field 2102. The hospital field 2104 stores some generic names, namely, dental and internal medicine in this example.

Referring to FIG. 8, when the user enters the postal code of the destination, to which the user is going to move, and clicks a go button 2122, a character house 2128 that is an image of a site at the destination is displayed. When the user moves the character 2124 to the character house 2128 using a mouse, the character 2124 is registered with the new address of the destination, and then the life-related information at the new address is searched for each of the items stores in the life data file 2126.

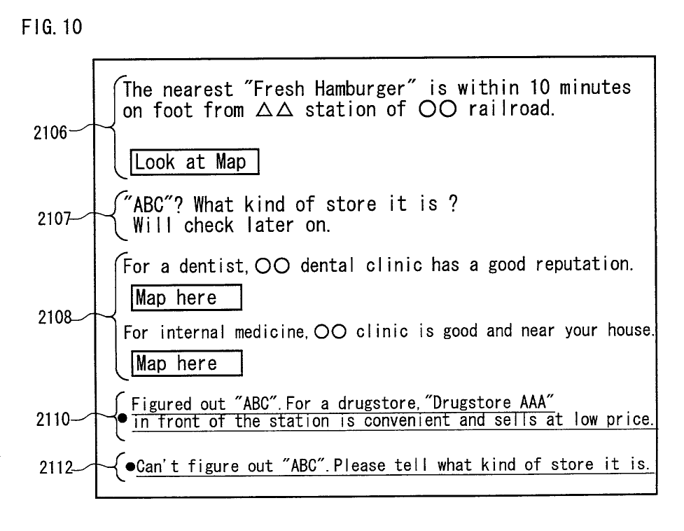

FIG. 10 explains a search result of the life-related information at the new address. The first paragraph 2106 describes where a shop called “Fresh Hamburger” registered in the frequented store field 2102 in the life data file 2126 is located at the new address. The user can refer to the map around the shop by clicking a “look at the map” button. The second paragraph 2107 is a message explaining that a shop called “ABC” registered in the frequented store field 2102 is not found at the new address and the searching server 2004 is now investigating what kind of store it is. In the third paragraph 2108, some clinics are recommended in respect to dental and internal medicine registered in the hospital field 2104. Thus, if the item registered in the life data file 2126 is a specific name or a proper noun, the searching server 2004 tells the user where a store or a hospital corresponding to the specific name is located at the new address. If the item is given as a generic name, a recommendable store or hospital is presented to the user.

The fourth paragraph 2110 is a message introducing “Drugstore AAA” as a recommendable drugstore at the new address. This message is provided to the user after the searching server 2004 judges “ABC” is a name of a drugstore by searching a Web page corresponding to “ABC”. The message is an html link as it is shown with an underline. By clicking the message, the user can access to the Web pages of “Drugstore AAA” and check whether the recommended store offers a similar service with the frequented store at the old address. The fifth paragraph 2112 is a message inquiring of the user when the searching server 2004 cannot know what kind of store “ABC” is. When the user clicks the message, a screen is displayed for the user to enter information about “ABC”.

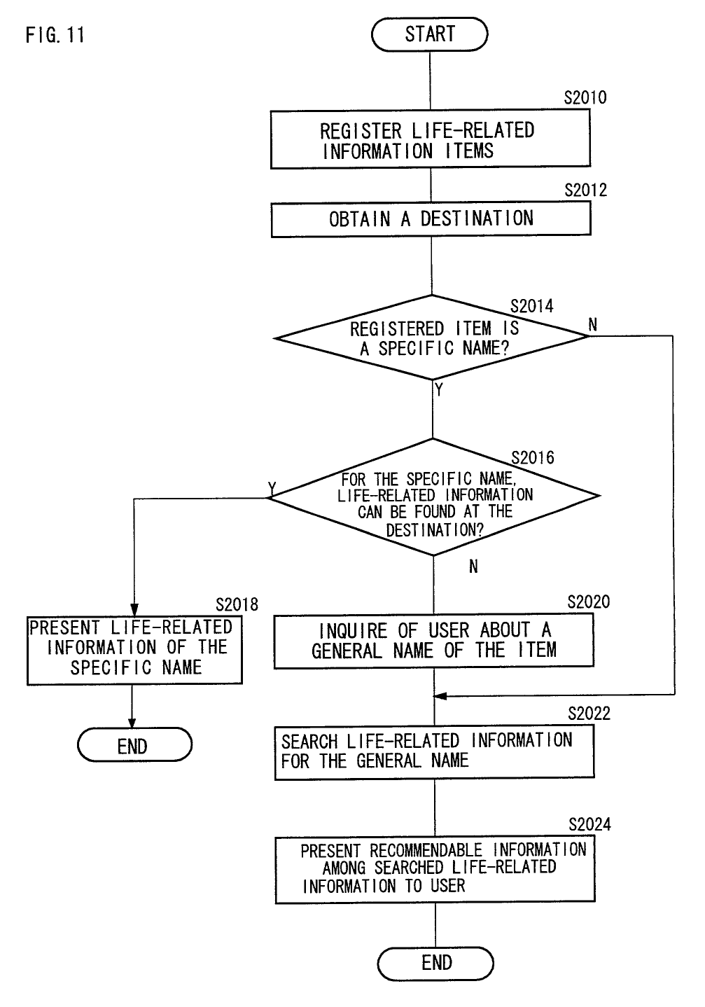

FIG. 11 shows a flow chart showing an information retrieval procedure by the searching server 2004 having the above-mentioned configuration. The registration data obtaining unit 2020 registers the life-related information items obtained from the user in the life-related information storing unit 2022 (S2010). The destination obtaining unit 2024 obtains the information related to the destination from the user (S2012). The searching unit 2026 checks whether each of the registered items is a specific name or not (S2014). The life-related information storing unit 2022 may have a list of generic names about the life-related information items, and the searching unit 2026 may judge whether the registered item is a specific name or a generic name using the list. If the item is a specific name (Y of S2014), the searching unit 2026 searches the life-related information corresponding to the specific name at the destination (S2016). If the search is successful (Y of S2016), the searched life-related information is offered to the user (S2018). If the search is not successful (N of S2016), the searching server 2004 inquires of the user about the generic name of the item (S2020). Instead of inquiring about the generic name, a generic name guessed by the searching unit 2026 may be proposed to the user.

If the item is not a specific name but a generic name (N of S2014) or when the user gives a generic name at the step S2020, the searching unit 2026 searches the life-related information at the destination corresponding to the generic name (S2022). The searching unit 2026 chooses recommendable information from the searched life-related information and proposes it to the user (S2024).

According to the searching server 2004 in this embodiment, when a user changes his/her location, the user can be provided with life-related information at the new location in respect to the registered items. Particularly, if any of the registered items is given as a specific name, and there is no information corresponding to the item at the new location, the server inquires of the user whether a general name should be guessed for the item and then searches the life-related information. For the item given as a generic name, some recommendable life-related information at the new location will be presented. Therefore, the users can get life-related information easily and automatically when they move, by just simply entering information on the new location, and they can save a lot of efforts for searching.

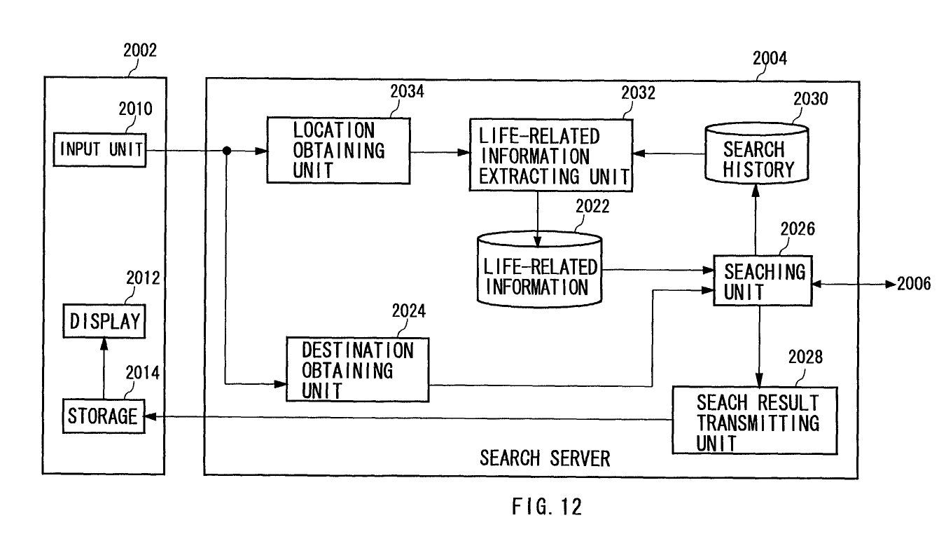

The third embodiment of the present invention is now explained. The searching server 2004 of this embodiment is different in its configuration and behavior from the one of the second embodiment, and the others remain the same. Therefore only different points are described here. FIG. 12 shows a block diagram of the user terminal 2002 and the searching server 2004. The searching server 2004 includes a location obtaining unit 2034, a life-related information extracting unit 2032, a search history storing unit 2030, a life-related information storing unit 2022, a searching unit 2026, a destination obtaining unit 2024, and a searching result transmitting unit 2028. The location obtaining unit 2034 obtains information related to the user location from the user terminal 2002 and outputs the information to the life-related information extracting unit 2032. The search history storing unit 2030 stores a history about information on the Internet searched by the user. The life-related information extracting unit 2032 extracts life-related information corresponding to the user location from the stored search history of the user, and registers the items of the life-related information in the life-related information storing unit 22. For instance, information on a hospital, a beauty salon, or a drugstore related to the present location of the user will be extracted. In this case, the specific name of the frequented store, or a subject of medical treatment such as dental or internal medicine will be registered as an item of the life-related information.

The destination obtaining 2024 obtains from the user terminal 2002 information related to the destination in moving, travel, and so on, and outputs the information to the searching unit 2026. The searching unit 2026 searches life-related information with regionality at the destination in respect to the items registered in the life-related information storing unit 2022. The search result transmitting unit 2028 transmits the search result to the user terminal 2002.

According to the searching server 2004 in this embodiment, since the items of life-related information of users are extracted from the search history of the users and registered beforehand, even if their location change, they can be provided with life-related information searched at the new location in respect to the registered items, by just simply entering information on the new location.

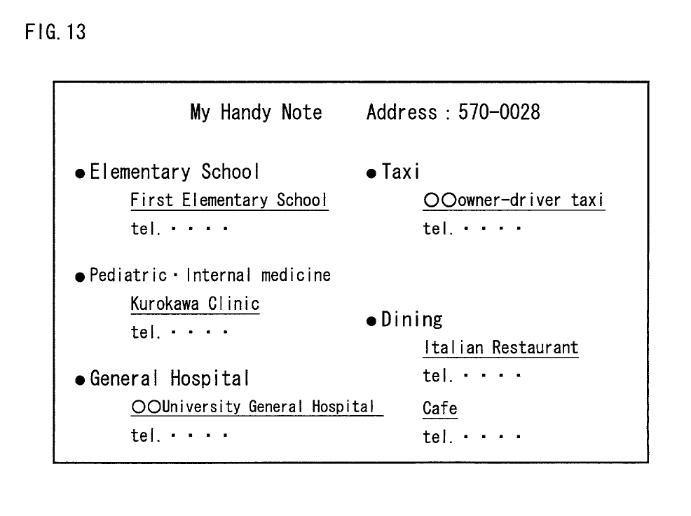

In the fourth embodiment of the present invention, the search history storing unit 2030, life-related information extracting unit 2032, and the life-related information storing unit 2022 of the searching server 2004 of the third embodiment are implemented in the user terminal 2002. The user terminal 2002 stores the search history of the user in the search history storing unit 2030, and extracts the items of the life-related information and registers the items in the life-related information storing unit 2022. The user terminal 2002 receives an input of the destination from the user, and transmits the destination and the life-related information items to the searching server 2004 as a query expression so that the terminal 2002 can receive from the searching server 2004 a search result of life-related information at the destination. The life-related information storing unit 2022 of the terminal 2002 may be configured as an address book or a handy note as it is common in a PDA terminal. FIG. 13 shows a note displayed in the user terminal 2002. It explains how life-related information with regionality at the user location can be registered. As the items of the life-related information, an elementary school, pediatric, internal medicine, a general hospital, taxi, and dining are registered. For each item, specific information local to the user location is registered as life-related information. The underline indicates that it is an html link. The user can access to a corresponding Web page by clicking the link.

According to the user terminal 2002 in this embodiment, since life-related information is extracted from the search history and a list of items of the life-related information is generated, the user terminal 2002 can search life-related information on each item in the Internet and register the searched information. Whenever the user changes the location, life-related information corresponding to the new location is searched again and registered.

Some alterations are now explained. Although life-related information at the destination is searched based on the items of life-related information in the above-mentioned embodiments, personal attributes of the user such as age, sex, preference, and hobbies may be registered beforehand and the life-related information may be searched based on these personal attributes. In this case, the user can obtain life-related information fit to his/her personal attributes, by just simply entering the destination in travel on business or on vacation. Therefore, for instance, the user can find a favorite restaurant before he/she travels, or find a nearby clinic when he/she goes on business.

In the above explanation, the user location and the destination are given by inputting an address or a postal code. If the user stays at the location or the destination, the current position data received from a GPS satellite or the current position data detected by a base station of a mobile phone or a PHS that the user has may be used as the position data of the user location or the destination.

Although the present invention has been described by way of exemplary embodiments, it should be understood that those skilled in the art might make many changes and substitutions without departing from the spirit and the scope of the present invention that is defined by the appended claims.

What is claimed is:

1. An information retrieval apparatus comprising:
an inputting unit which receives an input of a key word straightforwardly describing information to be searched by a user, and a place-name to apply a regional restriction to searching;
a selecting unit which selects a place-name of a region that is judged to be within a reachable area from a region indicated by the inputted place-name on the basis of a predefined judgment criterion;
a setting unit which sets a logical multiplication of a logical addition of the inputted place-name and the selected place-name, and the key word, as a query expression; and
a searching unit which searches the information by using the query expression.

2. An information retrieval apparatus comprising:
an inputting unit which receives a search term inputted by a user for searching information;
an extracting unit which extracts a place-name from the inputted search term;
a selecting unit which selects a place-name of a region that is judged to be within a reachable area from a region indicated by the extracted place-name on the basis of a predefined judgment criterion;
a setting unit which sets a query expression including a logical addition of the extracted place-name and the selected place-name; and
a searching unit which searches the information by using the query expression.

3. The apparatus of claim 1, wherein said selecting unit selects a place-name of a region within the reachable area by using a transfer means of the user as a determining factor.

4. The apparatus of claim 2, wherein said selecting unit selects a place-name of a region within the reachable area by using a transfer means of the user as a determining factor.

5. The apparatus of claim 1, further comprising a table which stores a place-name associated with absolute location information of a region indicated by the place-name, and wherein said selecting unit chooses from said table a place-name of a region from which the region indicated by the inputted place-name is far within a predefined distance, by using the absolute location information.

6. The apparatus of claim 2, further comprising a table which stores a place-name associated with absolute location information of a region indicated by the place-name, and wherein said selecting unit chooses from said table a place-name of a region from which the region indicated by the inputted place-name is far within a predefined distance, by using the absolute location information.

7. The apparatus of claim 2, further comprising a table which stores a proximity relation between regions indicated by place-names, and wherein said selecting unit chooses from said table a place name of a region that is in a high proximity to the region indicated by the inputted place-name, by using the proximity relation.

8. The apparatus of claim 2, further comprising a table which stores a inclusion relation between regions indicated by place-names, and wherein said selecting unit chooses from said table a place-name of a region that is included in the region indicated by the inputted place-name, by using the inclusion relation.

9. The apparatus of claim 2, wherein said inputting unit receives personal information of the user, and said selecting unit selects the place-name after modifying the reachable area using the personal information.

10. An information retrieval method comprising:
providing an interface for a user to input a search term for searching information;
obtaining the search term inputted via the interface;
extracting a place-name from the search term;
selecting a place-name of a region that is judged to be within a reachable area from a region indicated by the place-name on the basis of a predefined judgment criterion;
setting a query expression including a logical addition of the extracted place-name and the selected place-name; and
searching the information by using the query expression.

11. An information retrieval method comprising:
obtaining information related to a location of a user;
extracting an item of life-related information with regionality at the location from information retrieved by the user;
obtaining information related to a destination of the user; and
searching life-related information with regionality at the destination by using the extracted item.

12. An information retrieval method comprising:
storing an item of life-related information with regionality;
obtaining information related to a destination of a user; and
searching life-related information with regionality at the destination by using the stored item without receiving an input of the item from the user.

13. The method of claim 11, further comprising inquiring of the user about a generic name corresponding to the item when the item of the life-related information is given as a specific name and the life-related information with regionality at the destination corresponding to the specific name is not found.

14. The method of claim 12, further comprising inquiring of the user about a generic name corresponding to the item when the item of the life-related information is given as a specific name and the life-related information with regionality at the destination corresponding to the specific name is not found.

15. The method of claim 11, further comprising providing the user with recommendable information chosen from the searched information when the item of the life-related information is given as a generic name.

16. The method of claim 12, further comprising providing the user with recommendable information chosen from the searched information when the item of the life-related information is given as a generic name.

17. An information retrieval method comprising:
storing a personal attribute of a user;
obtaining information related to a destination of the user; and
searching life-related information with regionality at the destination by using the personal attribute without receiving a search item from the user.

18. An information retrieval apparatus comprising:
a life-related information storing unit which stores an item of life-related information with regionality for each user;
a destination obtaining unit which obtains information related to a destination of a user;
a searching unit which searches life-related information with regionality at the destination by using the stored item; and
a transmitting unit which transmits the searched life-related information to a terminal of the user.

19. The information retrieval apparatus, further comprising:
a search history storing unit which stores a history about information searched by the user;
a location obtaining unit which obtains information related to a location of the user; and
an extracting unit which extracts an item of life-related information with regionality at the location based on the history, and
wherein said life-related information storing unit stores the extracted item of the life-related information.

20. A terminal comprising:
a search history storing unit which stores a history about information searched by a user;
a location obtaining unit which obtains information related to a location of the user;
an extracting unit which extracts an item of life-related information with regionality at the location based on the history; and
a communication unit which transmits information related to a destination of the user and the extracted item to a server, and receives life-related information with regionality at the destination that is searched by the server.
